(19) United States
(12) Patent Application Publication
(10) Pub. No.: US 2016/0303761 A1
(43) Pub. Date: Oct. 20, 2016

(54) Method for Producing a Fiber Board Having Improved Chemical and Mechanical Properties

(71) Applicant: Cefla Deutschland GmbH, Meckenheim (DE)

(72) Inventor: Gerhard Stahl, Bad Neuenahr-Ahrweiler (DE)

(21) Appl. No.: 15/099,881

(22) Filed: Apr. 15, 2016

(30) Foreign Application Priority Data
Apr. 17, 2015 (DE) 10 2015 206 941.9

(51) Int. Cl. B27N 7/00; B27K 3/08

(52) U.S. Cl. CPC B27N 7/00; B27K 3/08

(57) ABSTRACT

In a method for producing a fiber board, particularly a hardened wood fiber board, liquid curing material is applied across the entire surface of a top side of the fiber board, wherein less than 500 ml of curing material are applied per m². By generating a pressure difference between the top side and the bottom side of the fiber board, the curing material will be sucked and/or pressed in. This makes it possible to produce customizable fiber boards at a later time, into which desired contours and grooves can be formed, wherein the required post-processing is simplified and, thus, the fiber boards can be produced in an inexpensive manner.

### CROSS-REFERENCE TO RELATED APPLICATION

This application claims priority to German Patent Application No. 10 2015 206 941.9 filed Apr. 17, 2015, the disclosure of which is hereby incorporated in its entirety by reference.

### BACKGROUND OF THE INVENTION

1. Field of the Invention

The present invention relates to a method for producing a fiber board having improved chemical and mechanical properties; such boards can be e.g. wood fiber boards or hemp fiber boards as well as glass or mineral wool boards. An exemplary embodiment will be explained herein by way of a wood fiber board.

2. Description of Related Art

For the production of furniture, door leaves and the like, it is known to use wood fiber boards. These consist of wood fiber boards attached to each other by pressing, which after the pressing process usually have a density of 450 to 1000 kg/m³. In a conventional wood fiber board that has not been partially post-processed by post-crosslinked polyurethane, it is required to lacquer the board several times, i.e. normally five or six times, for generating a high-grade lacquered surface, wherein abrading milling have to be performed between the individual lacquering steps. Still more technical expenditure is caused by the treatment of the wood fiber board in case that a structured surface shall be generated by the milling of grooves, cassettes or the like structures. This process has the consequence that the surface of the wood fiber board, e.g. in the area of the grooves or cassettes, is caused to become more porous because the milling will proceed through the thicker cover layer into the less dense medium layer. By being lacquered e.g. with water-soluble UV lacquers, water-based lacquers and the like, the fibers will be caused to attain an upright position and will thus require bothersome post-processing, frequently in the form of a manual abrasion process.

Further, it is known to soak the entire wood fiber board with suitable impregnating material such as e.g. post-crosslinking polyurethane. In such a process, a large quantity of the corresponding impregnating material is applied onto the board and will penetrate into the board and become cured. This makes it possible to reduce the number of lacquer layers that have to be applied for generating a high-grade lacquered surface. Then, it is also possible to generate a profiled surface by milling grooves or the like, wherein the bothersome abrasion steps, particularly those performed by hand, can be reduced. Under the economical aspect, however, such a method is disadvantageous since it necessitates the use of a very large quantity of expensive curing material. For this reason, it is known to apply the corresponding curing material only partially on an outer side of the wood fiber board and to suck the material into the wood fiber board by application of a vacuum to the underside of the wood fiber board, as described e.g. in DE 19 963 203. In such a method, it is required to apply at least 1000 ml of curing material per square meter.

The above method has the further disadvantage that, prior to the processing of the wood fiber board, the sites of the processing have to be exactly defined. It is not possible to use this method for producing a wood fiber board wherein the type of processing, such as e.g. the grooves and contours be to really milled into the board, will be defined only at later time.

It is an object of the invention to provide a method for producing a fiber board, particularly a hardened wood fiber board, wherein the fiber board can be processed in an individual manner, i.e. wherein it is possible to define the processing contours also at a later time.

According to the invention, the above object is achieved by the features defined in claim 1.

### SUMMARY OF THE INVENTION

The method of the invention will be explained in greater detail hereunder with reference to its preferred use in wood fiber boards, while the method is also suited for boards made of other materials treated by a liquid curing agent.

In the method of the invention, provided for producing a fiber board, particularly a hardened wood fiber board, liquid curing material is applied across the full surface of a top side of the fiber board. According to the invention, there are applied 400-800 ml, particularly 500-600 ml of liquid impregnating material per square meter are applied onto the top side of the wood fiber board, in case of a board thickness in the range of 6-10 mm, particularly 7-9 mm. In case of a smaller board thickness, a correspondingly lesser quantity of impregnating material will be applied. If the board thickness is reduced to half, also the applied quantity of impregnating agent will be reduced by 50%. In case of a board thickness of 2-6 mm, particularly 3-5 mm, impregnating material will be applied in a quantity of 200-400 mm, particularly 250-300 ml per square meter. With increasing board thickness and thus also increasing desired penetration depth of the impregnating material, correspondingly more impregnating material will be applied across the full surface of the top side of the fiber board. In a next step, a pressure difference is generated between the top side and the bottom side of the fiber board so as to suck and/or press the impregnating material into the wood fiber board across a large surface thereof. In this manner, the invention allows for a distinct reduction of the required quantity of impregnating material.

According to a particularly preferred embodiment of the method of the invention, application of impregnating material is performed onto both top sides. After deposition of the material onto a first top side and application of the pressure difference, it is thus provided according to a preferred embodiment of the invention that, in a next step, the board is turned around so that the previous bottom side will become the new top side and the previous top side will become the new bottom side. Subsequently, material will again be applied onto the present new top side wherein, again, the quantity of material will correspond to the above described application quantity in dependence on the board thickness.

Particularly by applying the impregnating material and causing it to be sucked in or pressed in from both sides, the mechanical properties of the board can be distinctly improved.

The board preferably has a density of 700-1100 kg/m³, particularly 800-1000 kg/m³. In spite of the relatively high density, the method of the invention makes it possible to cause the impregnating material to be sucked into the wood fiber board relatively deeply into the wood fiber board, particularly completely. This has the advantage that the mechanical properties of the board are considerably improved, while only a small quantity of impregnating material needs to be used.

In the first suction process, i.e. before the board is turned around, the periods of applying a pressure difference are 70-110 s, particularly 80-100 s. If, according to a preferred embodiment, the board is turned around and material is applied onto the resultant new top surface, the process of sucking or pressing in this material will then be performed for 10-25 s, particularly 15-20 s. Although the impregnating material is sucked in or pressed in from both sides, only a very small quantity of material will be sucked out from the board. This quantity is negligible.

Preferably, the pressure difference is generated by means of a vacuum chamber extending across the entire bottom side of the wood fiber board. Herein, both the full-surfaced application and the full-surfaced generation of underpressure are performed substantially across the entire surface of the board.

Further, it is preferred that the curing material is poured and/or sprayed onto the top side of the wood fiber board across the full surface thereof. Thereby, uniform application of the impregnating material can be realized.

As an impregnating material, it is preferred to use a self-curing system, a post-crosslinking polymer or the like.

Additionally or alternatively to this material, there can be used a two-component material capable of full curing, e.g. a polyurethane with isocyanate as a curing agent.

The polyurethane is provided with an isocyanate which will react in contact with water. The water in this case is the residual humidity of the MDF board. The reaction time is set to be very long and preferably is 3 days. The boards can be stacked after treatment and will not adhere to each other.

Preferably, the curing material used has a viscosity of 10 to 80 s, measured in a DIN 4 measuring jug.

The pressure difference between the top side and the bottom side of the wood fiber board is preferably in the range from 0.8 to 1.2 bar, this being dependent particularly on the air pressure. Since it is particularly preferred that there is performed exclusively a suctional intake, the pressure difference is maximally around 1 bar because the system is an open system. The provision of a vacuum chamber exclusively on the bottom side of the wood fiber board has the advantage that an hyperbaric chamber on the top side of the wood fiber board can be omitted.

Further, it is preferred that the differential pressure is generated by at least one vacuum pump connected to the vacuum chamber. Herein, the at least one vacuum pump or the plurality of vacuum pumps together have a suctional capacity of 700 to 1200 m³/h and particularly 800 to 1000 m³/h. This suctional capacity relates to a surface area of 1 m².

Preferably, with the aid of the method of the invention, the impregnating and respectively curing material is sucked and respectively pressed into the wood fiber board across a surface area of at least 3 mm, particularly into the complete wood fiber board. This will be the case particularly if the impregnating material is applied and pressed or sucked in from both sides.

Very good results were obtained by way of the exemplary embodiment defined hereunder:

Wood fiber board used: MDF 610 kg/m³, board thickness: 8 mm

Material used: POLYURETHANE with isocyanate

Curing time of the curing material: about 2 to 3 days

Application of 500 ml of curing material per square meter by casting.

Generating an underpressure of about 1000 mbar on the bottom side of the wood fiber board with the aid of three vacuum pumps having a suctional capacity of respectively 300 m³/h, with a surface area of the wood fiber board of 1 m².

In dependence on the air pressure, an underpressure of −920 mbar was reached. Depending on the penetration depth, the suction time is in the range from 20 to 90 s.

### BRIEF DESCRIPTION OF THE DRAWINGS

A full and enabling disclosure of the present invention, including the best mode thereof, enabling one of ordinary skill in the art to carry out the invention, is set forth in greater detail in the following description, including reference to the accompanying drawing in which

FIG. 1 is a schematic lateral view of a suitable device.

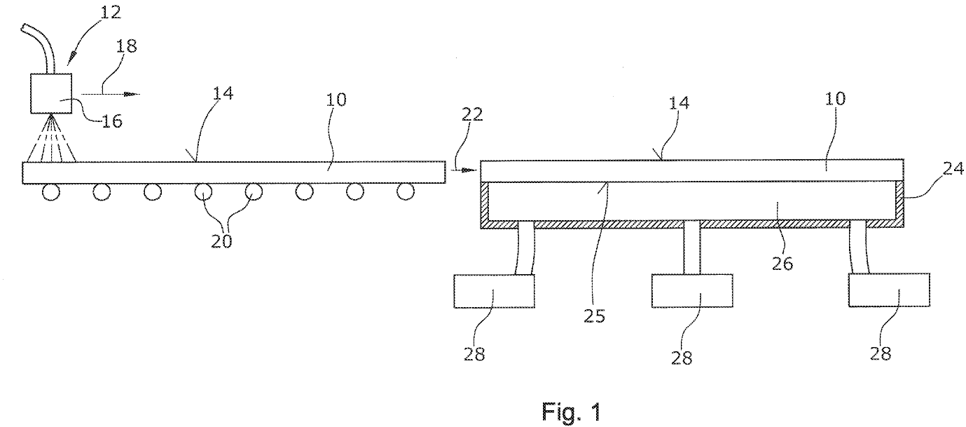

### DETAILED DESCRIPTION OF PREFERRED EMBODIMENTS

In a first station, a wood fiber board 10 produced by a conventional pressing method is, on a top side 14 of the board, sprayed on with curing material by use of a spraying device 12. For this purpose, the spray head 16 extending across the entire width of the wood fiber board 10 will be continuously moved in the direction indicated by arrow 18 along the entire length of the wood fiber board 10. In this manner, there is performed a uniform areal application of curing material onto said top side 14. For example with the aid of transport rollers 20, the wood fiber board is transported in the direction indicated by arrow 22 into the next processing station.

In the next processing station, the wood fiber board 10 is resting on a vacuum chamber 26 formed by an e.g. rectangular frame 24 extending on the edge of the wood fiber board 10. Vacuum chamber 26 is connected to three vacuum pumps 28. By means of the vacuum pumps 28, a pressure of about 1000 mbar is generated in the vacuum pump chamber 26 and thus on a bottom side 25 of the wood fiber board 10 for a period of about 90 seconds.

In this manner, the curing material arranged on the top side 14 of the wood fiber board 10 will be sucked in across the full surface of the board.

Subsequently, the wood fiber board 10 can be processed in an individual manner after the curing of the material. Thereby, while allowing for results of a very good quality, an individual profiling and structuring of the surface of the wood fiber board can be carried out by formation of grooves and the like. A bothersome—particularly manual—additional abrasion process prior to coating lacquer or the like onto the surface is not required anymore.

According to particularly preferred further embodiment of the invention, the process of applying impregnating material onto the top side 14 and causing the material to be sucked or pressed into the top side is followed by a step of turning the wood fiber board 10 around so that the bottom side 25 will become the new top side and the top side 14 will become the new bottom side. Subsequently, liquid curing material will again be applied onto the full surface and be caused to be sucked or pressed in, as described above. The only essential difference resides in that the suction and respectively pressing will be performed for a distinctly shorter period of particularly 10-25 s and, with particular preference, 15-20 s.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A method for producing a fiber board, said method comprising the steps of:
applying, across a full surface of a top side of a fiber board, impregnating a liquid material,
wherein 400-800 ml of impregnating material per square meter are applied in case of a board thickness in the range of 6-10 mm, and
wherein 200-400 ml of impregnating material per square meter are applied in case of a board thickness in the range of 2-6 mm, and
generating a pressure difference between the top side and a bottom side of the fiber board for sucking and/or pressing the impregnating material into the fiber board.

2. The method according to claim 1, comprising the additional steps of:
turning the fiber board around,
applying, across a full surface of a new top side of the fiber board, impregnating a liquid material side,
wherein 400-800 ml of impregnating material per square meter are applied in case of a board thickness in the range of 6-10 mm, and
wherein 200-400 ml of impregnating material per square meter are applied in case of a board thickness in the range of 2-6 mm, and
generating a pressure difference between the new top side and a new bottom side of the fiber board for sucking and/or pressing the impregnating material into the fiber board.

3. The method according to claim 1, wherein the density of the fiber board is 700-1100 kg/m³.

4. The method according to claim 1, wherein, for the suck-in or press-in process, the pressure difference between the top side and the bottom side is applied for 70-110 s.

5. The method according to claim 2, wherein, for the second suck-in or press-in process, the pressure difference between the new top side and the new bottom side is applied for 10-25 s.

6. The method according to claim 1, wherein the generating of the pressure difference is generated by a vacuum chamber extending across the entire bottom side of the fiber board.

7. The method according to claim 1, wherein the impregnating material is applied by casting and/or spraying onto the top side.

8. The method according to claim 1, wherein the impregnating material has a viscosity of 10 to 80 s, measured in a DIN 4 measuring jug.

9. The method according to claim 1, wherein the pressure difference is in the range from 0.8 to 1.2 bar.

10. The method according to claim 1, wherein the pressure difference is generated by at least one vacuum pump having a total suctional capacity of 700 to 1200 m³/h on a surface area of 1 m².

11. The method according to claim 1, wherein the impregnating material penetrates into the fiber board by at least 3 mm.

12. The method according to claim 1, wherein the fiber board is a wood fiber board.
